(19) United States
(12) Patent Application Publication
(10) Pub. No.: US 2011/0235328 A1
(43) Pub. Date: Sep. 29, 2011

(54) ENERGY HARVESTER FOR LED LUMINAIRE

(76) Inventors: Jian Xu, Windsor (CA); Thomas Alan Barnett, Ypsilanti, MI (US)

(21) Appl. No.: 12/731,169

(22) Filed: Mar. 25, 2010

(51) Int. Cl. F21S 4/00

(52) U.S. Cl. 362/249.02

(57) ABSTRACT

A light-emitting diode luminaire includes at least one light-emitting diode and at least one thermoelectric generator in contact with a portion of the luminaire. The at least one thermoelectric generator is operable to harvest energy from heat dissipated by the at least one light-emitting diode. An energy management module is operable to receive energy harvested by the at least one thermoelectric generator.

### BACKGROUND

This disclosure relates to energy harvesting, and more particularly to an energy harvester for a light-emitting diode (“LED”) luminaire.

LEDs have been used in luminaires to provide illumination and act as light-bulb replacements. Heatsinks have been used to dissipate heat from LEDs, because LEDs may become very hot while emitting light.

### SUMMARY

According to one non-limiting embodiment, a light-emitting diode luminaire includes at least one light-emitting diode and at least one thermoelectric generator in contact with a portion of the luminaire. The at least one thermoelectric generator is operable to harvest energy from heat dissipated by the at least one light-emitting diode. An energy management module is operable to receive energy harvested by the at least one thermoelectric generator.

According to one non-limiting embodiment, a light-emitting diode luminaire includes at least one light-emitting diode. A heatsink is operable to provide a path for heat dissipation away from the at least one light-emitting diode. At least one thermoelectric generator is in contact with a portion of the luminaire and is operable to harvest energy from heat dissipated by the at least one light-emitting diode. An energy management module is operable to receive and store energy harvested by the at least one thermoelectric generator.

According to one non-limiting embodiment, a method of operating a light-emitting diode luminaire includes passing current from a power source through at least one light-emitting diode to emit light, harvesting thermal energy from heat dissipated by the at least one light-emitting diode using at least one thermoelectric generator, and using the harvested thermal energy through an energy management module to provide power to a load.

These and other features of the present invention can be best understood from the following specification and drawings, the following of which is a brief description.

### BRIEF DESCRIPTION OF THE DRAWINGS

FIG. 1 schematically illustrates a LED luminaire operable to harvest thermal energy dissipated by a plurality of LEDs.

FIG. 2 schematically illustrates a printed circuit board operable to distribute power to the plurality of LEDs.

### DETAILED DESCRIPTION

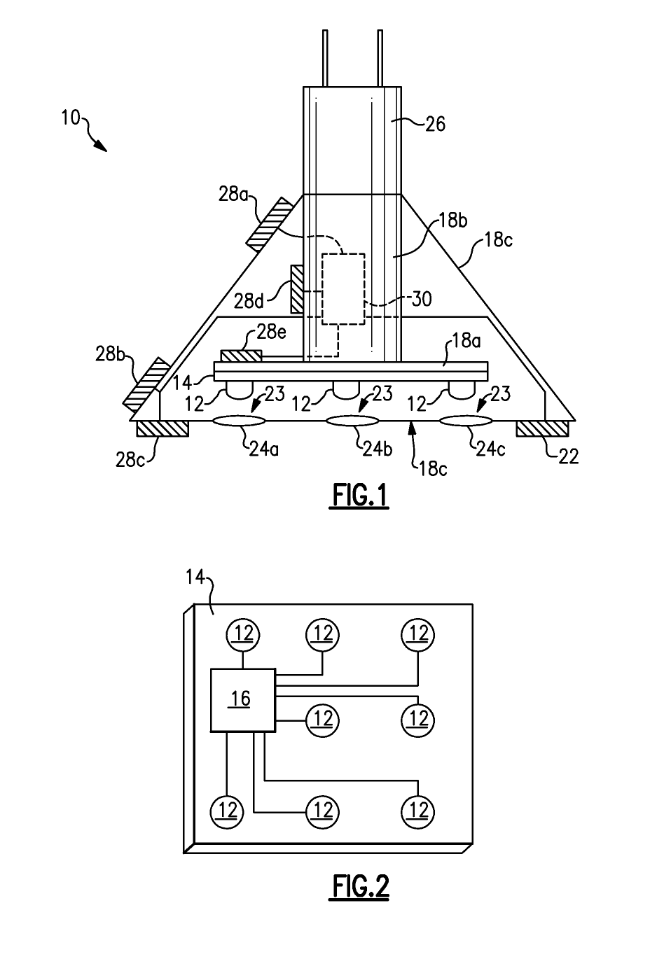

FIG. 1 schematically illustrates a LED luminaire 10 operable to harvest thermal energy dissipated by a plurality of LEDs 12. As shown in FIG. 2, the LEDs receive power through a printed circuit board (“PCB”) 14. A controller 16 on the PCB 14 is operable to control the LEDs 12 to change states (e.g., turn ON, turn OFF, change color, etc.).

A heat sink 18 is operable to provide a path for heat dissipation away from the plurality of LEDs 12. The heat sink includes first planar portion 18a in contact with the PCB 14, includes a second portion 18b transverse to the first portion, and includes a third housing portion 18c. The heatsink housing portion 18c surrounds the plurality of light-emitting diodes 12, the PCB 14 and the heat sink portions 18a-b.

The housing portion 18c includes a plurality of openings 23 through which light from the LEDs 12 may exit the housing. Each opening 23 has an associated optics portion 24 through which the light passes. In one example, each optics portion 24 is located beneath one of the plurality of LEDs 12. The optics portions 24 may include light pipes or light diffusers, for example. A connector 26 is able to detachably connect the luminaire 10 to a power source. In one example the connector 26 receives a DC voltage. In one example the connector 26 receives an AC voltage and performs an AC/DC conversion to provide a DC voltage to the plurality of LEDs 12.

The luminaire 10 includes one or more thermoelectric generators 28 that are in contact with the luminaire 10 and that are operable to harvest energy from heat dissipated by the plurality of LEDs 12. In one example the thermoelectric generators include Peltier devices. Of course, other thermoelectric generators 28 could be used. The thermoelectric generators 28 may be secured to the various heatsink portions 18a-c, for example. The thermoelectric generators 28 are able to harvest the most energy when placed in locations where the device has the largest temperature differential on each side. Therefore, a location such as the heatsink 18 can work well because one side of the generator 28 is secured to a hot surface and the other side of the generator 28 may be exposed to air that is cooler than the hot surface.

An energy storage and management module 30 receives and stores energy received from the thermoelectric generators 28. In one example the energy storage and management module 30 may be stored within the heatsink portion 18b. Of course, this is only an example and other locations would be possible. The energy storage and management module 30 may be used to power sensor 22, which may be a motion sensor, for example. In one example the luminaire 10 is configured to only turn OFF after a certain period of time if the sensor 22 detects no motion. Of course, other types of sensors could be used.

The energy storage and management module 30 may be used to provide at least a portion of the power for the LED control electronics (e.g. control 16) or the LED luminaire 10 itself. In one example the energy storage and management module 30 may omit storage functionality such that the module 30 only controls energy while the thermoelectric generators 28 are harvesting energy, and the module 30 does not provide power when the thermoelectric generators 28 are not harvesting energy.

Although multiple thermoelectric generators 28 and multiple thermoelectric generator 28 locations have been disclosed, it is understood that the disclosed quantity of thermoelectric generators 28 and the disclosed thermoelectric generator 28 locations are only examples. Also, it is understood that the luminaire 10 is only an example and that other LED luminaires could be used.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A light-emitting diode luminaire, comprising:
at least one light-emitting diode;
a heatsink operable to provide a path for heat dissipation away from the at least one light-emitting diode;
at least one thermoelectric generator in contact with a portion of the luminaire, the thermoelectric generator being operable to harvest energy from heat dissipated by the at least one light-emitting diode; and
an energy management module operable to receive energy harvested by the at least one thermoelectric generator.

2. The luminaire of claim 1, wherein the heat sink includes a first planar heatsink portion in contact with a printed circuit board, includes a second heatsink portion transverse to the first portion, and includes a housing portion that surrounds the at least one of light-emitting diode and surrounds the first and second heatsink portion.

3. The luminaire of claim 1, wherein the energy storage and management module acts as a power source to provide power for a sensor or to provide at least a portion of the power consumed by the LED luminaire.

4. The luminaire of claim 3, wherein the sensor is a motion sensor secured to a housing portion of the heatsink.

5. The luminaire of claim 1, wherein the at least one thermoelectric generator is in contact with the heatsink of the luminaire.

6. The luminaire of claim 1, wherein the energy management module also stores energy harvested by the at least one thermoelectric generator.

7. The luminaire of claim 1, wherein the thermoelectric generator includes a Peltier device.

8. The luminaire of claim 1, wherein the at least one light-emitting diode includes a plurality of light-emitting diodes that receive power from the energy management module through a printed circuit board.

9. A light-emitting diode luminaire, comprising:
at least one light-emitting diode;
at least one thermoelectric generator in contact with a portion of the luminaire, the at least one thermoelectric generator being operable to harvest energy from heat dissipated by the at least one light-emitting diode; and
an energy management module operable to receive energy harvested by the at least one thermoelectric generator.

10. The luminaire of claim 9, the luminaire further including a printed circuit board, wherein the at least one light-emitting diode includes a plurality of light-emitting diodes that are secured to the printed circuit board and that receive power through the printed circuit board.

11. The luminaire of claim 9, including a heatsink operable to provide a path for heat dissipation away from the at least one light-emitting diode.

12. The luminaire of claim 11, wherein the thermoelectric generator is secured to the heat sink.

13. The luminaire of claim 11, wherein the heat sink includes a first planar heatsink portion in contact with a printed circuit board, includes a second heatsink portion transverse to the first portion, and includes a housing portion that surrounds the at least one light-emitting diode and that surrounds the first and second heatsink portion.

14. The luminaire of claim 13, wherein the at least one light-emitting diode emits light through openings in the heatsink housing portion and through an optics portion located at the openings, the optics portion including at least one of a light pipe or a diffuser.

15. The luminaire of claim 9, wherein the thermoelectric generator includes a Peltier device.

16. A method of operating a light-emitting diode luminaire, comprising:
passing energy from an energy source through at least one light-emitting diode to emit light;
harvesting thermal energy from heat dissipated by the at least one light-emitting diode using at least one thermoelectric generator; and
using the harvested energy through an energy management module to provide power to a load.

17. The method of claim 16, including:
securing the at least one thermoelectric generator to a heatsink; and
dissipating heat away from the at least one light-emitting diode using the heatsink such that the thermoelectric generator is able to harvest thermal energy.

18. The method of claim 16, the luminaire having a housing, the method including:
commanding the at least one light-emitting diode to transition from a first state to a second state using a controller within the housing.

19. The method of claim 16, wherein said using the harvested energy through an energy management module to provide power to a load includes providing power for a sensor, providing at least a portion of the power consumed by the LED luminaire, or both.

20. The method of claim 16, including securing the at least one thermoelectric generator to a housing that surrounds the at least one light-emitting diode and energy management module.
